(19) United States
(12) Patent Application Publication
(10) Pub. No.: US 2026/0023291 A1
(43) Pub. Date: Jan. 22, 2026

(54) DISPLAY SUBSTRATE AND DISPLAY DEVICE

(71) Applicant: Beijing Shiyan Technology Co., Ltd., Beijing (CN)

(72) Inventors: Lizhen Zhang, Beijing (CN); Fuqiang Li, Beijing (CN); Jian Gao, Beijing (CN); Xiaolong Li, Beijing (CN); Hongrun Wang, Beijing (CN); Changfeng Li, Beijing (CN); Zhongyuan Wu, Beijing (CN); Xue Dong, Beijing (CN)

(73) Assignee: Beijing Shiyan Technology Co., Ltd., Beijing (CN)

(21) Appl. No.: 18/996,325

(22) PCT Filed: May 14, 2024
(86) PCT No.: PCT/CN2024/093082

§ 371 Date: Jan. 17, 2025

(30) Foreign Application Priority Data
Jun. 7, 2023 (CN) 202310667879.4

(51) Int. Cl. G02F 1/1362; G06F 3/041

(52) U.S. Cl. CPC G02F 1/136286; G02F 1/136209; G02F 1/136222; G06F 3/0412; G06F 3/04164

(57) ABSTRACT

The present disclosure provides a display substrate and a display device. The display substrate includes a base substrate and an array of pixel islands on the base substrate. The pixel island includes an array of sub-pixels; the display substrate further includes a plurality of data lines and a plurality of gate lines, and a plurality of pixel aperture areas defined by intersections of the plurality of data lines and the plurality of gate lines. The sub-pixel includes a control circuit and a pixel electrode coupled to each other; the control circuit is further coupled to the corresponding data line and gate line, respectively; the control circuit is used to, under control of the gate line, control turning on or off an electrical connection between the data line and the pixel electrode; the pixel electrode is simultaneously located in at least two adjacent pixel aperture areas.

### CROSS-REFERENCE TO RELATED APPLICATIONS

This application claims priority to Chinese Patent Application No. 202310667879.4 filed in China on Jun. 7, 2023, the entire contents of which are hereby incorporated by reference.

### TECHNICAL FIELD

The present disclosure relates to the field of display technologies, and more particularly, to a display substrate and a display device.

### BACKGROUND

Due to the presence of depth information, 3D display can realize many functions that 2D display does not have. However, most electronic products today are still at the level of 2D display, which is related to the level of previous image processing technology. With development of science and technology, the image processing technology has made great progress. The current image processing hardware has achieved characteristics of miniaturization, high efficiency and low heat generation. Meanwhile, various optical solutions for 3D display have emerged one after another, thereby laying foundation for the popularization of the 3D display technology. The 3D display has become a display trend in the future. However, due to the limitations of the backplane process, the existing 3D display cannot form a continuously luminous display backplane.

### SUMMARY

An object of the present disclosure is to provide a display substrate and a display device.

In order to achieve the above object, the present disclosure provides the following technical solutions.

In a first aspect of the present disclosure, a display substrate is provided and includes: a base substrate and an array of pixel islands on the base substrate; wherein the pixel island includes an array of sub-pixels; the display substrate further includes a plurality of data lines and a plurality of gate lines, and a plurality of pixel aperture areas defined by intersections of the plurality of data lines and the plurality of gate lines;

wherein the sub-pixel includes a control circuit and a pixel electrode coupled to each other; the control circuit is further coupled to the corresponding data line and gate line, respectively; the control circuit is used to, under control of the gate line, control turning on or off an electrical connection between the data line and the pixel electrode; the pixel electrode is simultaneously located in at least two adjacent pixel aperture areas.

Optionally, the data line includes a first data-line portion and a second data-line portion coupled to each other; an orthographic projection of the first data-line portion onto the base substrate at least partially overlaps with an orthographic projection of the pixel electrode onto the base substrate, and an orthographic projection of the second data-line portion onto the base substrate does not overlap with the orthographic projection of the pixel electrode onto the base substrate; the second data-line portion is coupled to the control circuit;

wherein an included angle a between an extending direction of the first data-line portion and an extending direction of the pixel electrode satisfies: 0°<a<90°.

Optionally, tan(a)=i/j; j=pitch1/3, pitch1 is a width of the pixel island along an extension direction of the second data-line portion, i=pitch2/m, pitch2 is a width of the pixel island along an extension direction of the gate line, and m is the number of sub-pixels included in one row of sub-pixels in the pixel island along the extension direction of the gate line.

Optionally, i/j=1, or i/j=1/2.

Optionally, the first data-line portion and the second data-line portion both extend along a first direction; the pixel electrode extends along a second direction; the angle a is defined between the second direction and the first direction; the pixel electrode is simultaneously located in at least two pixel aperture areas adjacent to each other along the extension direction of the gate line.

Optionally, the sub-pixels are divided into a plurality of sub-pixel rows; each sub-pixel row corresponds to one gate line, and each sub-pixel in the sub-pixel row is respectively coupled to the corresponding gate line.

Optionally, the sub-pixels are divided into multiple sub-pixel rows; each sub-pixel row corresponds to two gate lines, at least a portion of the sub-pixel row is located between the two gate lines; a portion of the sub-pixels in the sub-pixel row are respectively coupled to one corresponding gate line, and another portion of the sub-pixels in the sub-pixel row are respectively coupled to another corresponding gate line.

Optionally, the sub-pixels are divided into multiple sub-pixel columns; and two adjacent sub-pixel columns correspond to the same data line; an orthographic projection of the data line onto the base substrate is located between orthographic projections of two adjacent sub-pixel columns onto the base substrate, and each sub-pixel in the two adjacent sub-pixel columns is coupled to the corresponding data line. respectively.

Optionally, the sub-pixel further includes common electrodes; the common electrode is arranged opposite to the pixel electrode; the common electrodes included in the display substrate are divided into multiple common electrode groups, and the common electrodes belonging to the same common electrode group are coupled together; the display substrate further includes touch electrodes and touch signal lines coupled to the touch electrodes; the common electrode groups are reused as the touch electrodes.

Optionally, the display substrate further includes a virtual data line; the virtual data line is located between adjacent data lines; the virtual data line is reused as the touch signal line.

Optionally, the pixel electrode and the second data-line portion both extend along a first direction, the first data-line portion extends along a second direction; an angle a is defined between the second direction and the first direction; the pixel electrode is simultaneously located in at least two pixel aperture areas adjacent to each other along the first direction.

Optionally, the base substrate includes a display area and a peripheral area located around the display area; the display substrate further includes a touch electrode and a touch signal line coupled to each other; the touch electrode is located in the display area; the touch signal line includes a first touch portion and a second touch portion coupled to each other; the first touch portion is in the same extension direction as the gate line, at least a portion of the first touch portion is located in the display area; the second touch portion is located in the peripheral area, and an extension direction of the second touch portion crosses an extension direction of the first touch portion.

Optionally, the touch signal line is located between the touch electrode and the base substrate, or the touch signal line is located on a side of the touch electrode that is away from the base substrate;

an insulating layer is provided between the touch signal line and the touch electrode, and the touch signal line is coupled to the touch electrode via a via-hole which extends through the insulating layer.

Optionally, the insulating layer includes an organic insulating layer or an inorganic insulating layer.

Optionally, the display substrate further includes a lens structure; the lens structure is located at a light-emitting side of the multiple pixel islands; an angle between an axial direction of the lens structure and an extension direction of the gate line is greater than 0 degrees and less than 90 degrees.

Optionally, the axial direction of the lens structure is the same as the extension direction of the pixel electrode, or is the same as the extension direction of the first data-line portion.

Based on the above technical solution of the display substrate, a second aspect of the present disclosure provides a display device, including the above display substrate, and a color filter substrate; wherein the color filter substrate is arranged opposite to the display substrate.

Optionally, the color filter substrate includes a black matrix; an extension direction of the black matrix is the same as an extension direction of the gate line in the display substrate; an orthographic projection of the black matrix onto the base substrate of the display substrate at least partially overlaps with an orthographic projection of the first touch portion in the display substrate onto the base substrate.

### BRIEF DESCRIPTION OF THE DRAWINGS

The drawings described herein are used to provide a further understanding of the present disclosure and constitute a part of the present disclosure. The exemplary embodiments of the present disclosure and their descriptions are used to explain the present disclosure and do not constitute an improper limitation on the present disclosure. In the drawings:

FIG. 1 is a schematic cross-sectional view of a display device according to an embodiment of the present disclosure;

FIG. 2 is a schematic diagram of obtaining values of i and j according to an embodiment of the present disclosure;

FIG. 3 is a schematic diagram of a first layout of a display substrate according to an embodiment of the present disclosure;

FIG. 4 is a schematic diagram of a first layout of a display substrate according to an embodiment of the present disclosure;

FIG. 5 is a schematic diagram of a second layout of a display substrate according to an embodiment of the present disclosure;

FIG. 6 is a schematic diagram of a third layout of a display substrate according to an embodiment of the present disclosure;

FIG. 7 is a schematic diagram of a fourth layout of a display substrate according to an embodiment of the present disclosure;

FIG. 8 is a schematic diagram of light emission brightness of each grayscale of a display substrate according to an embodiment of the present disclosure;

FIG. 9 is a schematic diagram showing comparison of light emission brightness of adjacent sub-pixels of a display substrate according to an embodiment of the present disclosure;

FIG. 10 is a schematic diagram showing that an extending direction of pixel electrodes is parallel to an axial direction of a lens structure in a display substrate according to an embodiment of the present disclosure;

FIG. 11 is a schematic diagram of layout of touch signal lines in the related art;

FIG. 12 is a schematic diagram of layout of touch signal lines according to an embodiment of the present disclosure;

FIG. 13 is a schematic top view showing that a touch signal line is coupled with a touch electrode a via--hole according to an embodiment of the present disclosure;

FIG. 14 is a first cross-sectional schematic diagram along A1A2 direction in FIG. 13;

FIG. 15 is a first cross-sectional schematic diagram along B1B2 direction in FIG. 13;

FIG. 16 is a second cross-sectional schematic diagram along A1A2 direction in FIG. 13;

FIG. 17 is a second cross-sectional schematic diagram along B1B2 direction in FIG. 13;

FIG. 18 is a third cross-sectional schematic diagram along A1A2 direction in FIG. 13;

FIG. 19 is a third cross-sectional schematic diagram along B1B2 direction in FIG. 13;

FIG. 20 is a fourth cross-sectional schematic diagram along A1A2 direction in FIG. 13; and

FIG. 21 is a fourth cross-sectional schematic diagram along B1B2 direction in FIG. 13.

### DETAILED DESCRIPTION

In order to further illustrate the display substrate and the display device provided in the embodiments of the present disclosure, a detailed description is given below in conjunction with the accompanying drawings.

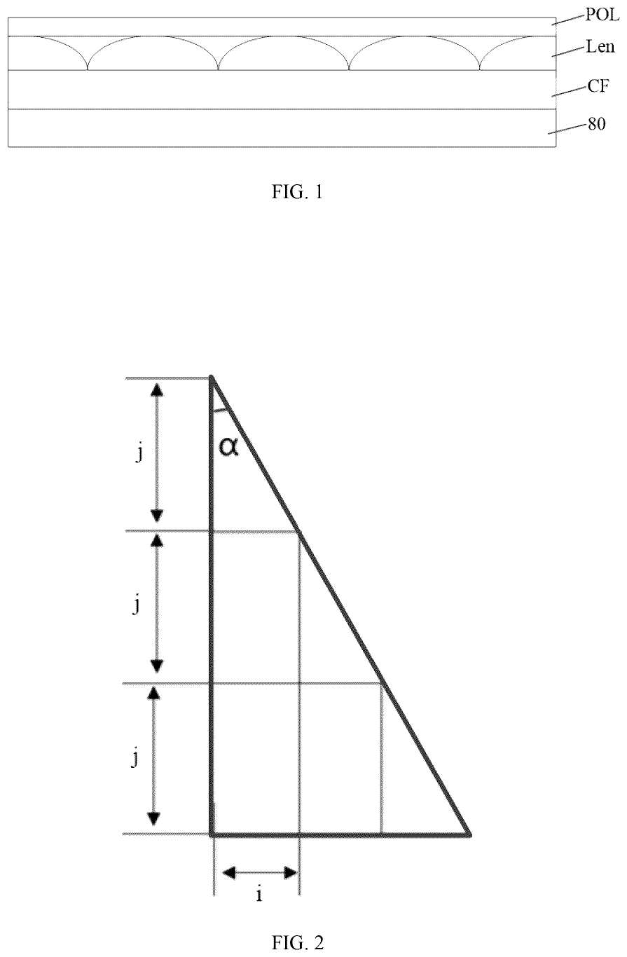

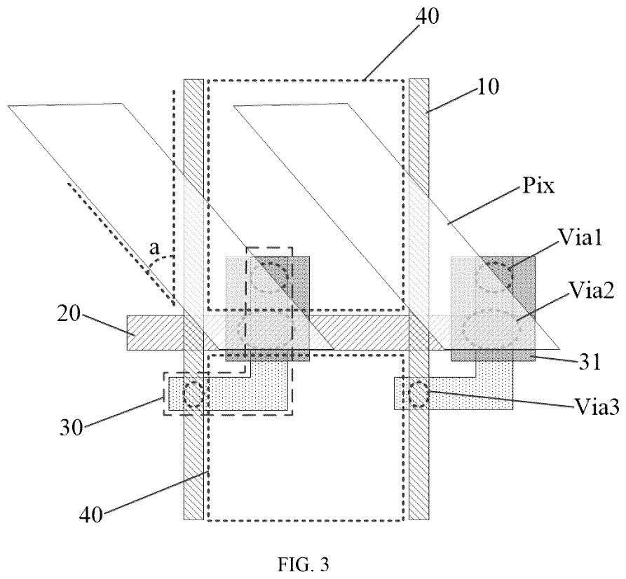

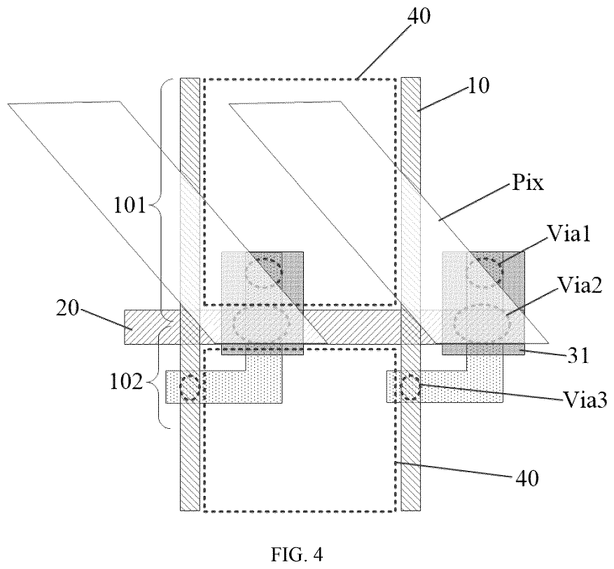

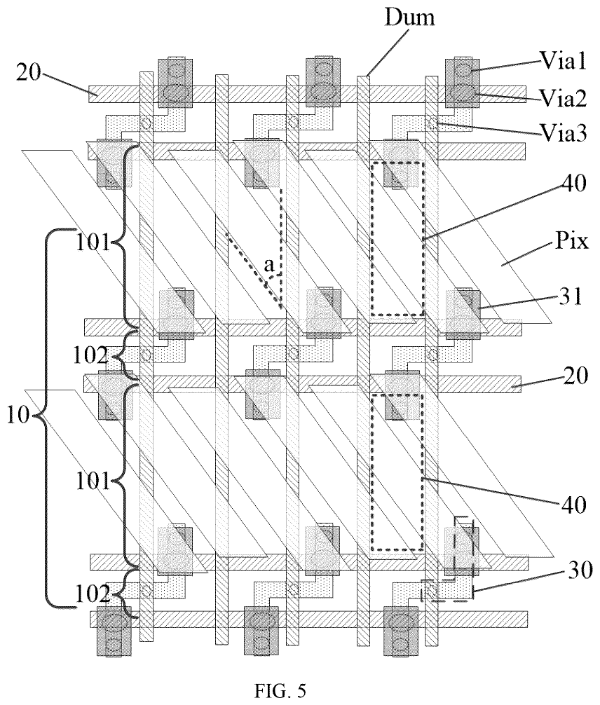

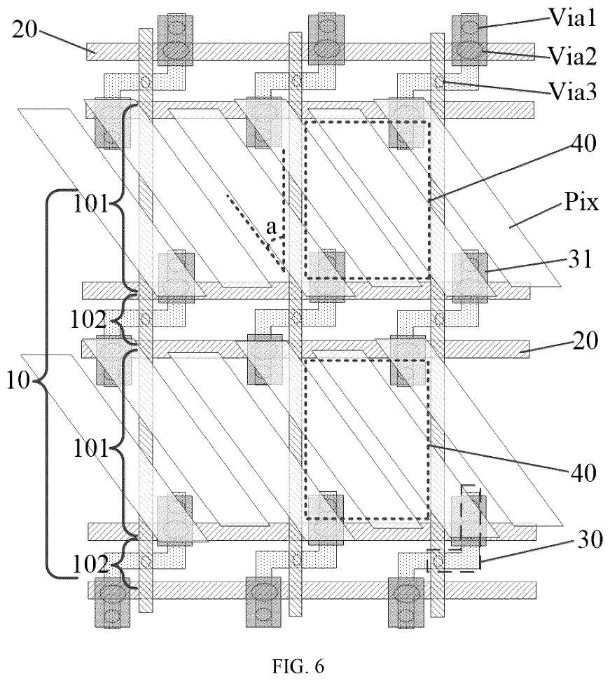

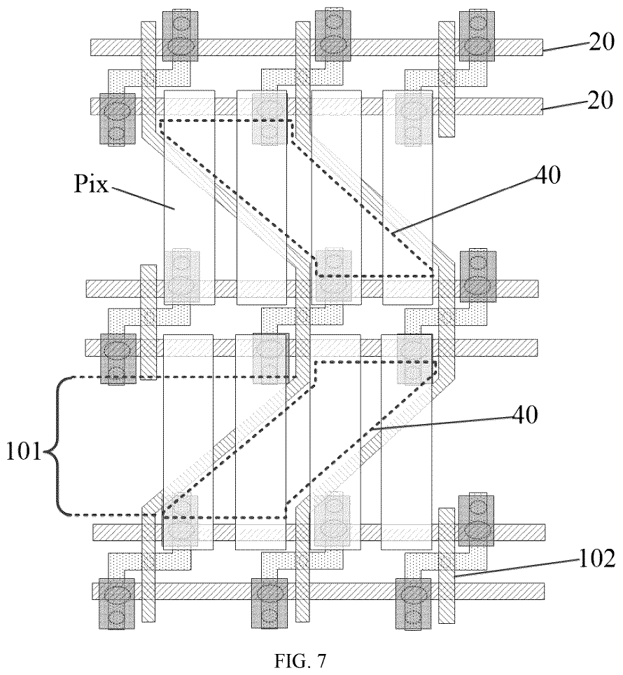

Referring to FIG. 1, FIG. 3, FIG. 4, FIG. 5, FIG. 6 and FIG. 7, one embodiment of the present disclosure provides a display substrate 80, which includes a base substrate and a plurality of pixel islands arranged in an array on the base substrate. The pixel island includes a plurality of sub-pixels arranged in an array. The display substrate 80 further includes a plurality of data lines 10 and a plurality of gate lines 20, and a plurality of pixel aperture areas 40 defined by intersections of the plurality of data lines 10 and the plurality of gate lines 20.

The sub-pixel includes a control circuit 30 and a pixel electrode Pix coupled to each other. The control circuit 30 is further coupled to the corresponding data line 10 and gate line 20, respectively. The control circuit 30 is used to, under control of the gate line 20, control turning on or off an electrical connection between the data line 10 and the pixel electrode Pix. The pixel electrode Pix is simultaneously located in at least two adjacent pixel aperture areas 40.

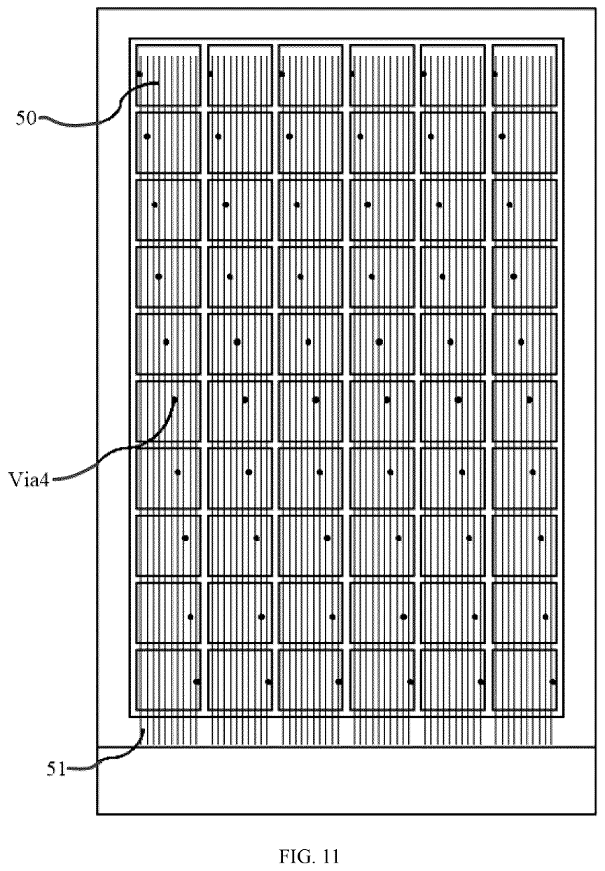

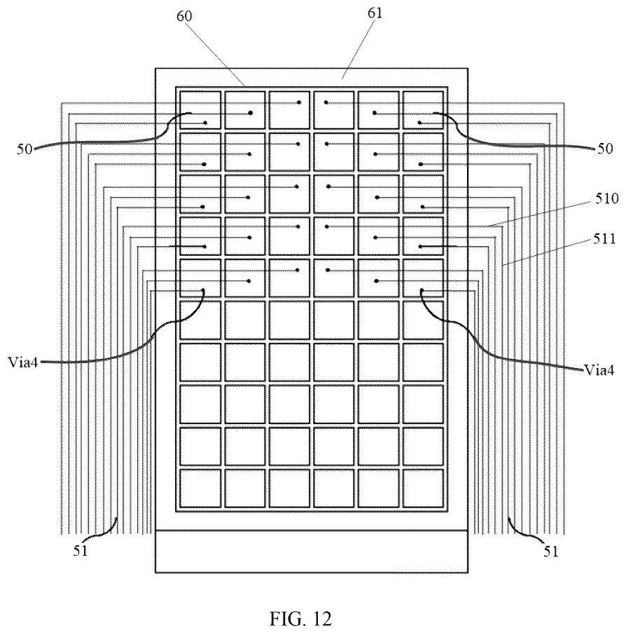

As shown in FIG. 12, exemplarily, the substrate includes a display area 60 and a peripheral area 61 located around the display area 60. The peripheral area 61 may at least partially surround the display area 60. For example, the peripheral area 61 surrounds the display area 60. The plurality of pixel islands is located in the display area 60.

Exemplarily, the pixel island may include m View numbers, where m is an integer. For example, the pixel island includes 9 View numbers, 12 View numbers, etc., but is not limited thereto. In more detail, in a case where the pixel island includes 9 View numbers, the pixel island includes 3 rows of sub-pixels×9 columns of sub-pixels, and the 3 rows of sub-pixels include one row of red sub-pixels, one row of green sub-pixels, and one row of blue sub-pixels, each of the rows of sub-pixels of different colors includes 9 sub-pixels arranged in sequence. In a case where the pixel island includes 12 View numbers, the pixel island includes 3 rows of sub-pixels×12 columns of sub-pixels, and the 3 rows of sub-pixels include one row of red sub-pixels, one row of green sub-pixels, and one row of blue sub-pixels, and each of the rows of sub-pixels of different colors include 12 sub-pixels arranged in sequence. It should be noted that View can be understood as a sub-pixel.

Exemplarily, the display substrate 80 further includes a plurality of data lines 10 and a plurality of gate lines 20, an extension direction of the gate line 20 crosses an extension direction of the data line 10. The gate lines 20 and the data lines 10 are arranged in different layers. The plurality of data lines 10 and the plurality of gate lines 20 cross each other to define a plurality of pixel aperture areas 40. The pixel aperture area 40 includes an active area of the display substrate 80.

Exemplarily, the sub-pixel includes a control circuit 30 and a pixel electrode Pix coupled to each other, and the sub-pixel further includes a common electrode. The common electrode is arranged relative to the pixel electrode Pix in a direction perpendicular to the base substrate. The control circuit 30 is further coupled to the corresponding data line 10 and gate line 20, respectively. The control circuit 30 is used to, under control of a control signal transmitted by the gate line 20. control turning on or off an electrical connection between the data line 10 and the pixel electrode Pix, so as to transmit a data signal transmitted by the data line 10 to the pixel electrode Pix, thereby forming a control electric field between the pixel electrode Pix and the common electrode. The control electric field can drive liquid crystals located between the pixel electrode Pix and the common electrode to deflect, thereby realizing the display function of the display substrate 80.

Exemplarily, the control circuit 30 includes a control transistor. A gate electrode of the control transistor is coupled to the gate line, a first electrode of the control transistor is coupled to the data line 10 through a third via-hole Via3, and a second electrode of the control transistor is coupled to the pixel electrode Pix. Exemplarily, the second electrode of the control transistor is coupled to a transition graphic 31 through a first via-hole Via1, and the transition graphic 31 is coupled to the pixel electrode Pix through a second via-hole Via2. The transition graphic 31 can be made of the same layer and material as other film layers in the display substrate 80, for example, it can be made of the same layer and material as the data line 10; it can also be formed by adding a special patterning process, for example, it can be made of indium tin oxide material; but not limited to this.

Exemplarily, different display modes are used to improve transmittance of a display panel. For example, the display modes of the display substrate 80 include an advanced super dimension switch (hereinafter referred to as ADS) display mode, and an upgraded version of ADS display mode, high advanced dimension switch (HADS) display mode.

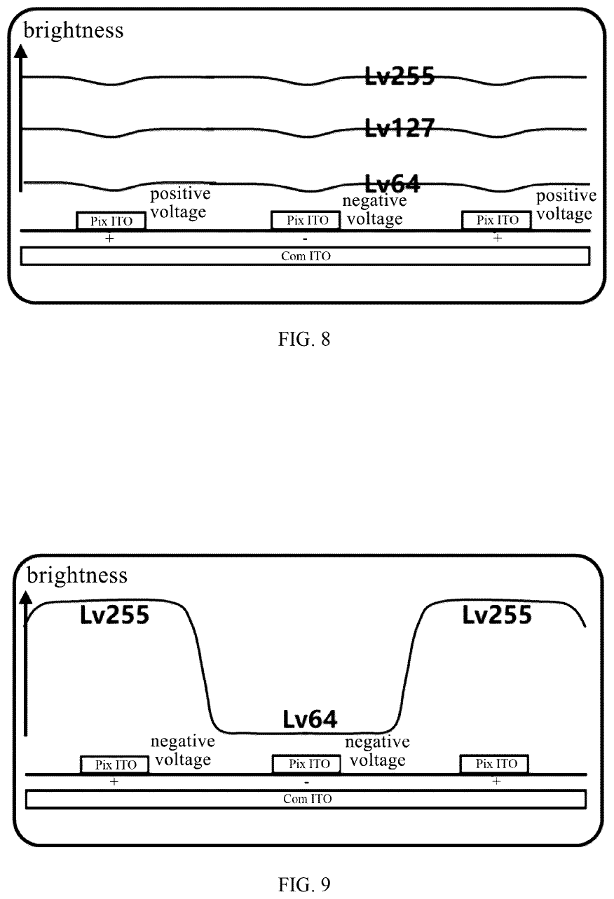

Exemplarily, the pixel island may adopt electrical polarity column reverse, row reverse and/or surface reverse in the ADS display mode. The pixel island may adopt electrical polarity column reverse in the HADS display mode, but is not limited thereto. This method can better improve interference between adjacent sub-pixels. In more detail, as shown in FIG. 8 and FIG. 9, adjacent pixel electrodes have positive and negative voltages that are reversed alternately.

Exemplarily, the pixel electrode Pix is simultaneously located in at least two adjacent pixel aperture areas 40. For example, the pixel electrode Pix is simultaneously located in two adjacent pixel aperture areas 40, or three adjacent pixel aperture areas 40, but not limited thereto.

Exemplarily, the pixel electrode Pix is simultaneously located in at least two adjacent pixel aperture areas 40, and the pixel electrode Pix can span a region between adjacent pixel aperture areas 40 in the at least two adjacent pixel aperture areas 40, and the region between the adjacent pixel aperture areas 40 is not covered by a black matrix (BM), that is, the black matrix (BM) used to cover the region can be removed.

Exemplarily, the pixel electrode Pix is simultaneously located in at least two adjacent pixel aperture areas 40, and the at least two adjacent pixel aperture areas 40 are arranged along an extension direction of the gate line 20, or the at least two adjacent pixel aperture areas 40 are arranged along an extension direction of the pixel electrode Pix, but is not limited thereto.

Exemplarily, areas of the pixel electrode Pix in the pixel aperture areas 40 are the same or different.

Exemplarily, the number of pixel electrodes Pix included in each pixel aperture area 40 is greater than or equal to two. For example, the number of pixel electrodes Pix included in each pixel aperture area 40 is three or four, but not limited thereto.

According to the specific structure of the display substrate 80, in the display substrate 80 provided in the embodiment of the present disclosure, by setting the pixel electrode Pix to be located in at least two adjacent pixel aperture areas 40 at the same time, the pixel electrode Pix can span the region between the adjacent pixel aperture areas 40 in the at least two adjacent pixel aperture areas 40, and the region between the adjacent pixel aperture areas 40 is not covered by the black matrix (BM), so that a control electric field between the pixel electrode Pix and the common electrode can be formed in the at least two adjacent pixel aperture areas 40 as well as in the region between the adjacent pixel aperture areas 40 in the at least two adjacent pixel aperture areas 40, thereby achieving continuous display and high-definition display in the at least two adjacent pixel aperture areas 40. Meanwhile, the problem of displaying rainbow patterns caused by removing the black matrix (BM) used to cover the region between the adjacent pixel aperture areas 40 is also solved. Therefore, when the display substrate 80 provided in the embodiment of the present disclosure is applied to a 3D display product, continuous luminous effect of 3D display can be effectively achieved.

In more detail, as shown in FIG. 8 and FIG. 9, in FIG. 8, at different grayscales, such as Lv64, Lv127 and Lv255, display brightness uniformity of areas where various sub-pixels are located is high. In FIG. 9, when adjacent sub-pixels display different grayscales, the interference between the various sub-pixels is small.

As shown in FIG. 3 to FIG. 7, in some embodiments, the data line 10 includes a first data-line portion 101 and a second data-line portion 102 coupled to each other. An orthographic projection of the first data-line portion 101 onto the base substrate at least partially overlaps with an orthographic projection of the pixel electrode Pix onto the base substrate, and an orthographic projection of the second data-line portion 102 onto the base substrate does not overlap with the orthographic projection of the pixel electrode Pix onto the base substrate. The second data-line portion 102 is coupled to the control circuit 30.

An included angle a between an extending direction of the first data-line portion 101 and an extending direction of the pixel electrode Pix satisfies: 0°<a<90°.

Exemplarily, the first data-line portion 101 and the second data-line portion 102 are formed as an integrated structure. For example, the first data-line portion 101 and the second data-line portion 102 are both made of a source-drain metal layer in the display substrate 80, but is not limited thereto.

Exemplarily, at least part of the first data-line portion 101 is located between adjacent pixel aperture areas 40, and an orthographic projection of the first data-line portion 101 onto the base substrate does not overlap with an orthographic projection of the gate line 20 onto the base substrate.

Exemplarily, an orthographic projection of the second data-line portion 102 onto the base substrate does not overlap with the orthographic projection of the pixel electrode Pix onto the base substrate, and the orthographic projection of the second data-line portion 102 onto the base substrate partially overlaps with the orthographic projection of the gate line 20 onto the base substrate.

Exemplarily, an extending direction of the first data-line portion 101 is the same as an extending direction of the pixel aperture area 40.

In the display substrate 80 provided in the above embodiment, by setting the angle a between the extension direction of the first data-line portion 101 and the extension direction of the pixel electrode Pix to satisfy 0°<a<90°, that is, the angle a between the extension direction of the pixel aperture area 40 and the extension direction of the pixel electrode Pix satisfies 0°<a<90°, the tilted pixel design can achieve that the pixel electrode Pix is simultaneously located in at least two adjacent pixel aperture areas 40, so that the pixel electrode Pix can span the gap between adjacent pixel aperture areas 40 in the at least two adjacent pixel aperture areas 40. In this way, a control electric field can be formed between the pixel electrode Pix and the common electrode in the at least two adjacent pixel aperture areas 40 as well as in the gap between adjacent pixel aperture areas 40 in the at least two adjacent pixel aperture areas 40, thereby achieving continuous display and high-definition display in the at least two adjacent pixel aperture areas 40.

In the display substrate 80 provided in the above embodiment, the interference between sub-pixels is small, and the center of the sub-pixel is almost unaffected, so that the continuous light emission design can be well realized.

As shown in FIG. 2 to FIG. 7, in some embodiments, tan(a)=i/j; j=pitch1/3, pitch1 is a width of the pixel island along the extension direction of the second data-line portion 102. i=pitch2/m, pitch2 is a width of the pixel island along the extension direction of the gate line 20, and m is the number of sub-pixels included in one row of sub-pixels in the pixel island along the extension direction of the gate line 20.

Exemplarily, the gate line 20 extends in a horizontal direction, and the second data-line portion 102 extends in a vertical direction, but is not limited thereto.

Exemplarily, the pixel island includes three rows of sub-pixels, and pitch1 is set as a width of the pixel island along the extension direction of the second data-line portion 102, then j=pitch1/3, j is a width of one row of sub-pixels along the extension direction of the second data-line portion 102.

Exemplarily, pitch2 is set as a width of the pixel island along the extension direction of the gate line 20, m is the number of sub-pixels included in one row of sub-pixels in the pixel island along the extension direction of the gate line 20, then i=pitch2/m, i is a width of one sub-pixel along the extension direction of the gate line 20.

Exemplarily, i and j may select an integer value part of an actually calculated value, but are not limited thereto.

Exemplarily, in a case where the pixel island includes 9 View numbers. the value i/j=1, and a is equal to 45°, but is not limited thereto.

Exemplarily, in a case where the pixel island includes 12 View numbers, the value i/j=1/2, and a is equal to arctan (1/2), but is not limited thereto.

In the display substrate 80 provided in the above embodiment, by setting tan(a)=i/j. it can achieve that the pixel electrode Pix is simultaneously located in at least two adjacent pixel aperture areas 40, so that the pixel electrode Pix can span the gap between adjacent pixel aperture areas 40 in the at least two adjacent pixel aperture areas 40. In this way, a control electric field can be formed between the pixel electrode Pix and the common electrode in the at least two adjacent pixel aperture areas 40 as well as in the gap between adjacent pixel aperture areas 40 in the at least two adjacent pixel aperture areas 40, thereby achieving continuous display and high-definition display in the at least two adjacent pixel aperture areas 40.

As shown in FIG. 3 to FIG. 6, in some embodiments, the first data-line portion 101 and the second data-line portion 102 both extend along a first direction; the pixel electrode Pix extends along a second direction. The angle a is defined between the second direction and the first direction. The pixel electrode Pix is simultaneously located in at least two pixel aperture areas 40 adjacent to each other along the extension direction of the gate line 20.

Exemplarily, the first direction includes a vertical direction, but is not limited thereto.

The above setting mode can realize that the pixel electrode Pix is located in at least two adjacent pixel aperture areas 40 at the same time, so that the pixel electrode Pix can span the gap between adjacent pixel aperture areas 40 in the at least two adjacent pixel aperture areas 40. In this way, a control electric field can be formed between the pixel electrode Pix and the common electrode in the at least two adjacent pixel aperture areas 40 as well as in the gap between adjacent pixel aperture areas 40 in the at least two adjacent pixel aperture areas 40, thereby realizing continuous display and high-definition display in the at least two adjacent pixel aperture areas 40.

As shown in FIG. 3 and FIG. 4. in some embodiments, the plurality of sub-pixels is divided into a plurality of sub-pixel rows. Each sub-pixel row corresponds to one gate line 20, and each sub-pixel in the sub-pixel row is respectively coupled to the corresponding gate line 20.

As shown in FIG. 5 and FIG. 7, in some embodiments, the plurality of sub-pixels is divided into multiple sub-pixel rows. Each sub-pixel row corresponds to two gate lines 20, at least a portion of the sub-pixel row is located between the two gate lines 20; a portion of the sub-pixels in the sub-pixel row are respectively coupled to one corresponding gate line 20, and another portion of the sub-pixels in the sub-pixel row are respectively coupled to another corresponding gate line 20.

In more detail, one sub-pixel row may correspond to one gate line 20 or two gate lines 20. In the case where each sub-pixel row corresponds to two gate lines 20, odd-numbered sub-pixels in the sub-pixel row may be coupled to one corresponding gate line 20, and even-numbered sub-pixels in the sub-pixel row may be coupled to another corresponding gate line 20, but is not limited thereto.

As shown in FIG. 3 and FIG. 4, in some embodiments, the plurality of sub-pixels is divided into multiple sub-pixel columns, and the multiple sub-pixel columns correspond to the multiple data lines 10 in the display substrate 80 in a one-to-one manner. The data line 10 is respectively coupled to each sub-pixel in the corresponding sub-pixel column.

As shown in FIG. 6 and FIG. 7, in some embodiments, the plurality of sub-pixels is divided into multiple sub-pixel columns, and two adjacent sub-pixel columns correspond to the same data line 10. An orthographic projection of the data line 10 onto the base substrate is located between orthographic projections of two adjacent sub-pixel columns onto the base substrate, and each sub-pixel in the two adjacent sub-pixel columns is coupled to the corresponding data line 10, respectively.

It should be noted that, under the above configuration, each sub-pixel row can be set to correspond to two gate lines 20 at the same time.

The above configuration can effectively reduce the number of data lines 10 in the display substrate 80 and improve a pixel aperture ratio of the display substrate 80.

As shown in FIG. 12, in some embodiments, the sub-pixel further includes common electrodes. The common electrode is arranged opposite to the pixel electrode Pix. The multiple common electrodes included in the display substrate 80 are divided into multiple common electrode groups, and the common electrodes belonging to the same common electrode group are coupled together. The display substrate 80 further includes touch electrodes 50 and touch signal lines 51 coupled to the touch electrodes. The common electrode groups are reused as the touch electrodes 50.

Exemplarily, the common electrode is located between the pixel electrode Pix and the base substrate; or, the pixel electrode Pix is located between the common electrode and the base substrate.

Exemplarily, various common electrodes in the same common electrode group are formed into a whole-surface integrated structure. Alternatively, various common electrodes in the same common electrode group can be electrically connected via a conductive connection portion arranged in a different layer.

Exemplarily, the common electrode group is reused as the touch electrode 50, and the touch electrode 50 is coupled to a corresponding touch signal line 51, and the touch signal line 51 is used to transmit a touch signal.

In the display substrate 80 provided in the above embodiment, by setting the common electrode to be reused as the touch electrode 50, not only the touch function is integrated into the display substrate 80, but also the additional process of manufacturing the touch electrode 50 is avoided, which effectively simplifies the manufacturing process of the display substrate 80 and reduces the manufacturing cost.

As shown in FIG. 5, in some embodiments, the display substrate 80 further includes: a virtual data line Dum. The virtual data line Dum is located between adjacent data lines 10. The virtual data line Dum is reused as the touch signal line 51.

Exemplarily, the touch signal line 51 includes a driving signal line, but is not limited thereto.

In more detail, two adjacent sub-pixel columns are set to correspond to the same data line 10, so that the saved data line 10 is a virtual data line Dum. and the virtual data line Dum can be used as the touch signal line 51. This avoids adding an additional process for manufacturing the touch signal line 51, thereby effectively simplifies the manufacturing process of the display substrate 80, and reducing the manufacturing cost.

In some embodiments, the virtual data line Dum can be reused as the conductive connection portion.

As shown in FIG. 7. in some embodiments, the pixel electrode Pix and the second data-line portion 102 both extend along the first direction, the first data-line portion 101 extends along the second direction. The angle a is defined between the second direction and the first direction. The pixel electrode Pix is simultaneously located in at least two pixel aperture areas 40 adjacent to each other along the first direction.

The above setting method can realize that the pixel electrode Pix is located in at least two adjacent pixel aperture areas 40 at the same time, so that the pixel electrode Pix can span the gap between adjacent pixel aperture areas 40 in the at least two adjacent pixel aperture areas 40. In this way, a control electric field can be formed between the pixel electrode Pix and the common electrode in the at least two adjacent pixel aperture areas 40 as well as in the gap between adjacent pixel aperture areas 40 in the at least two adjacent pixel aperture areas 40, thereby realizing continuous display and high-definition display in the at least two adjacent pixel aperture areas 40.

As shown in FIG. 12, in some embodiments, the base substrate includes a display area 60 and a peripheral area 61 located around the display area 60. The display substrate 80 further includes a touch electrode 50 and a touch signal line 51 coupled to each other through a fourth via-hole Via4. The touch electrode 50 is located in the display area 60. The touch signal line 51 includes a first touch portion 510 and a second touch portion 511 coupled to each other. The first touch portion 510 is in the same extension direction as the gate line 20, at least a portion of the first touch portion 510 is located in the display area 60. The second touch portion 511 is located in the peripheral area 61, and an extension direction of the second touch portion 511 crosses an extension direction of the first touch portion 510.

It should be noted that FIG. 12 only shows a layout of the touch signal lines 51 in an upper half, and a layout of the touch signal lines 51 in a lower half is the same as that in the upper half.

Exemplarily, the first touch portion 510 can be shielded by the existing black matrix BM, and there is no need to add an additional black matrix BM to shield the first touch portion 510.

As shown in FIG. 11, it shows that most of touch signal lines 51 in the related art are arranged in the display area 60. This arrangement will affect the aperture ratio of the display substrate 80.

In the display substrate 80 provided in the above embodiment, the touch signal line 51 is arranged to include the first touch portion 510 and the second touch portion 511, and a portion of the first touch portion 510 is located in the display area 60, and the second touch portion 511 is completely located in the peripheral area 61. This arrangement reduces the influence of the touch signal line 51 on the pixel aperture ratio of the display substrate 80, and effectively improves the pixel aperture ratio of the display substrate 80.

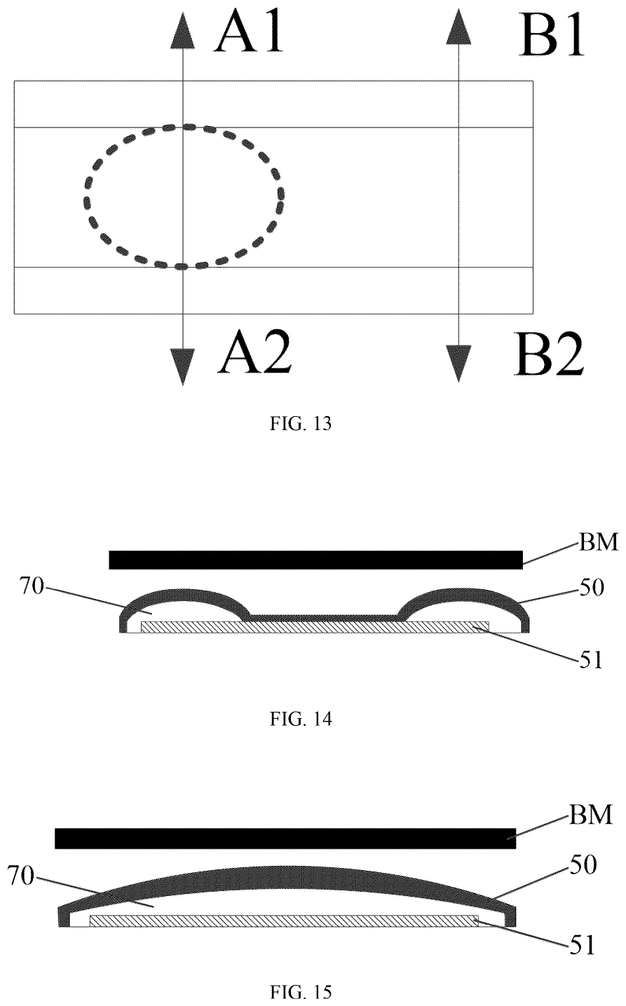

As shown in FIG. 13 to FIG. 21, in some embodiments, the touch signal line 51 is located between the touch electrode 50 and the base substrate, or the touch signal line 51 is located on a side of the touch electrode 50 that is away from the base substrate.

An insulating layer is provided between the touch signal line 51 and the touch electrode 50, and the touch signal line 51 is coupled to the touch electrode 50 via a via-hole which extends through the insulating layer.

Exemplarily, the insulating layer includes an organic insulating layer 70 or an inorganic insulating layer 71. The insulating layer may be retained on an entire surface or only in a wiring area.

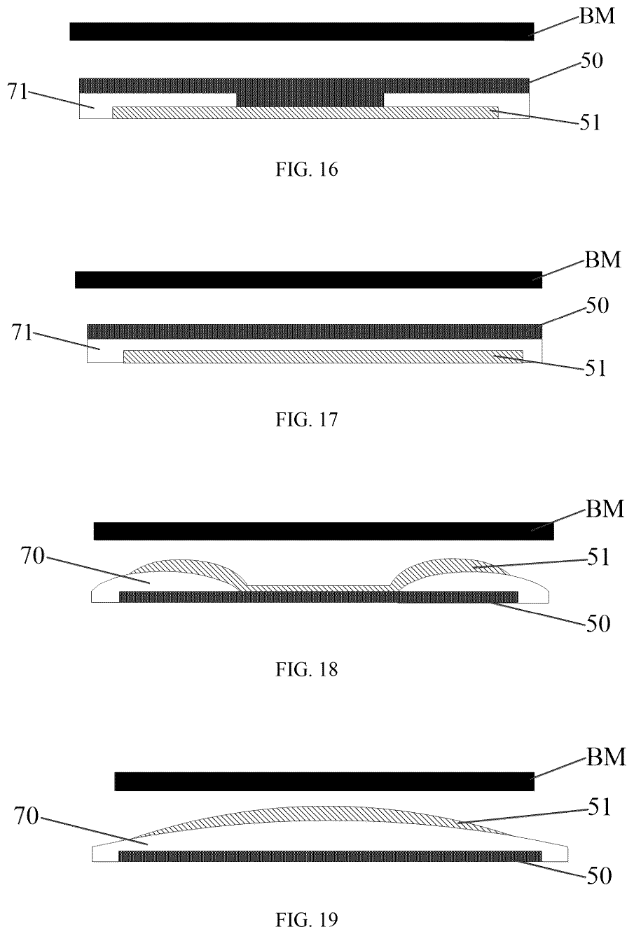

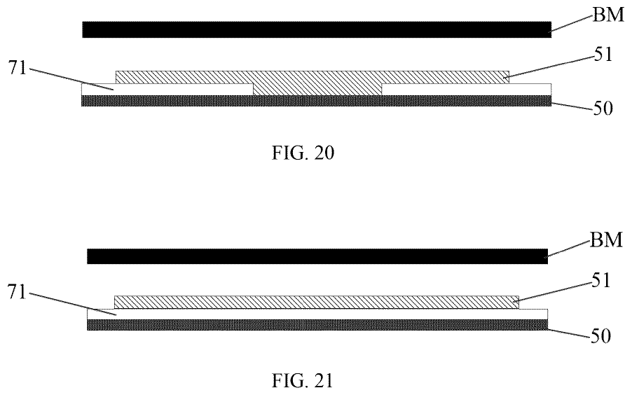

As shown in FIG. 14 and FIG. 15, they show that the touch signal line 51 is located between the touch electrode 50 and the base substrate, and an organic insulating layer 70 is provided between the touch signal line 51 and the touch electrode 50. As shown in FIG. 16 and FIG. 17, they show that the touch signal line 51 is located between the touch electrode 50 and the base substrate, and an inorganic insulating layer 71 is provided between the touch signal line 51 and the touch electrode 50. As shown in FIG. 18 and FIG. 19, they show that the touch signal line 51 is located on a side of the touch electrode 50 facing away from the base substrate, and an organic insulating layer 70 is provided between the touch signal line 51 and the touch electrode 50. As shown in FIG. 20 and FIG. 21, they show that the touch signal line 51 is located on a side of the touch electrode 50 facing away from the base substrate, and an inorganic insulating layer 71 is provided between the touch signal line 51 and the touch electrode 50.

Exemplarily, the organic insulating layer 70 may be a planarization layer, and the inorganic insulating layer 71 may be a passivation layer, but is not limited thereto.

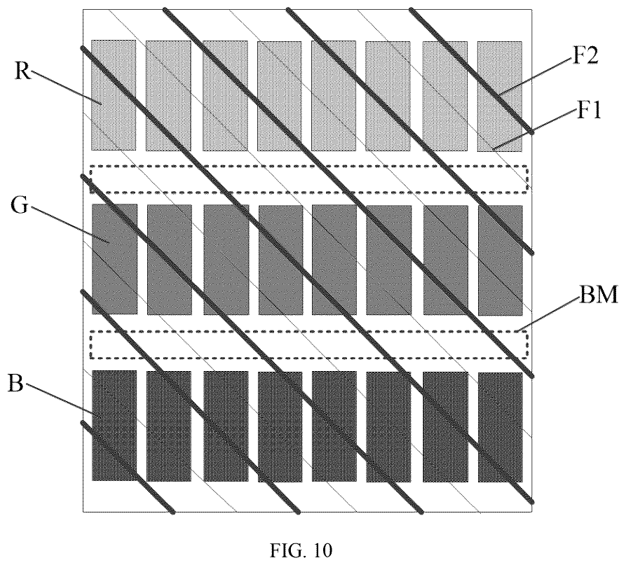

As shown in FIG. 1 and FIG. 10, in some embodiments, the display substrate 80 further includes a lens structure. The lens structure is located at a light-emitting side of the multiple pixel islands. An angle between an axial direction of the lens structure and the extension direction of the gate line 20 is greater than 0 degrees and less than 90 degrees.

It should be noted that FIG. 1 also shows a polarizer POL.

Exemplarily, the lens structure includes a plurality of cylindrical lenses distributed in an array, and the axial direction of the lens structure is an axial direction of the cylindrical lenses.

Exemplarily, as shown in FIG. 10, an axial direction F2 of the lens structure is the same as the extension direction (such as an F1 direction) of the pixel electrode Pix, or is the same as the extension direction (such as the F1 direction) of the first data-line portion 101. It should be noted that the extension direction of the pixel electrodes Pix included in the red sub-pixel R, the green sub-pixel G and the blue sub-pixel B in FIG. 10 is the F1 direction, and the RGB rectangular blocks shown in the figure are visual effects, and regions between adjacent rectangular blocks are provided with data lines.

In the display substrate 80 provided in the above embodiment, the constructed tilted pixels are combined with the lens structure to realize continuous luminous 3D display function, and more continuous and clearer displayed information. At the same time, the purpose of realizing 3D display at multiple angles can be achieved simultaneously.

In the display substrate 80 provided in the above embodiment, by setting the axial direction of the lens structure to be the same as the extension direction of the pixel electrode Pix, or the same as the extension direction of the first data-line portion 101, the lens structure and the sub-pixels together form a display unit. The display unit can form a multi-directional 3D display effect and can form a 3D picture in horizontal or vertical screen.

As shown in FIG. 1, one embodiment of the present disclosure further provides a display device, including the display substrate 80 provided in the above embodiment. The display device further includes a color filter substrate CF. The color filter substrate CF is arranged opposite to the display substrate 80.

Exemplarily, the display device further includes a liquid crystal layer, and the liquid crystal layer is located between the display substrate 80 and the color filter substrate CF.

It should be noted that the display device can be any product or component with a display function, such as a television, a monitor, a digital photo frame, a mobile phone, a tablet computer, etc. The display device further includes a flexible circuit board, a printed circuit board and a backplane, etc.

According to the specific structure of the display substrate 80, in the display substrate 80 provided in the embodiment of the present disclosure, by setting the pixel electrode Pix to be located in at least two adjacent pixel aperture areas 40 at the same time, the pixel electrode Pix can span the region between the adjacent pixel aperture areas 40 in the at least two adjacent pixel aperture areas 40, and the region between the adjacent pixel aperture areas 40 is not covered by the black matrix BM, so that a control electric field between the pixel electrode Pix and the common electrode can be formed in the at least two adjacent pixel aperture areas 40 as well as in the region between the adjacent pixel aperture areas 40 in the at least two adjacent pixel aperture areas 40, thereby realizing continuous display in the at least two adjacent pixel aperture areas 40. Meanwhile, the problem of displaying rainbow patterns caused by removing the black matrix (BM) used to cover the region between the adjacent pixel aperture areas 40 is also solved. Therefore, when the display substrate 80 provided in the embodiment of the present disclosure is applied to a 3D display product, continuous luminous effect of 3D display can be effectively achieved.

In some embodiments, the color filter substrate CF includes a black matrix BM, an extension direction of the black matrix BM is the same as the extension direction of the gate line 20 in the display substrate 80. An orthographic projection of the black matrix BM onto the base substrate of the display substrate 80 at least partially overlaps with the orthographic projection of the first touch portion 510 in the display substrate 80 onto the base substrate.

Exemplarily, the display substrate 80 further includes a color filter pattern, and an orthographic projection of at least a portion of the black matrix BM onto the display substrate 80 is located between adjacent sub-pixels of different colors.

The above setting of the orthographic projection of the black matrix BM onto the base substrate of the display substrate 80 at least partially overlapping with the orthographic projection of the first touch portion 510 in the display substrate 80 onto the base substrate, enables the black matrix BM to shield the first touch portion 510, thereby avoiding the first touch portion 510 from affecting the display effect of the display substrate 80, and then ensuring the display quality of the display substrate 80.

It is to be noted that one signal line extending in an X direction means that the signal line includes a main part and a secondary part connected to the main part. the main part is a line, line segment or bar-shaped body, the main part extends in the X direction. and an extension length of the main part along the X direction is greater than an extension length of the secondary part along other directions.

It is to be noted that the “same layer” in the embodiments of the present disclosure may refer to film layers on a same layer. Or, for example, film layers in the same layer may be a layer structure formed by using the same film formation process to form a film layer for forming specific patterns and then using the same mask to pattern the film layer through a patterning process. Depending on the specific patterns, one patterning process may include multiple exposure, development or etching processes, and specific patterns in the formed layer structure may be continuous or discontinuous. These specific patterns may also be at different heights or have different thicknesses.

In the various method embodiments of the present disclosure, serial numbers of various steps cannot be used to limit sequence of various steps. For those of ordinary skill in the art, without exerting creative work, changes to the sequence of various steps are also within the protection scope of the present disclosure.

It is to be noted that the various embodiments in this specification are described in a progressive manner. Each embodiment focuses on differences from other embodiments. and the same or similar parts between the various embodiments may be referred to each other. In particular, for the method embodiment, since it is basically similar to the product embodiment, the description is relatively simple, and relevant details can be found in the description of the product embodiment.

Unless otherwise defined, any technical or scientific terms used herein shall have the common meaning understood by a person of ordinary skills. Such words as “first” and “second” used in the specification and claims are merely used to differentiate different components rather than to represent any order, number or importance. Similarly, such words as “including” or “comprising” mean that an element or thing appearing before the word includes elements or things listed after the word and their equivalents, without excluding other elements or things. Such words as “connect”, “coupling” or “connected to” may include electrical connection, direct or indirect. rather than being limited to physical or mechanical connection. Such words as “on/above”, “under/below”, “left” and “right” are merely used to represent relative position relationship, and when an absolute position of an object is changed, the relative position relationship will be changed too.

It is to be understood that when an element such as a layer, film, area or substrate is referred to as being “on” or “under” another element, the element may be “directly on” or “under” the another element, or an intermediate element may be present.

In the description of the above embodiments, specific features, structures, materials, or characteristics may be combined in any suitable manner in any one or more embodiments or examples.

The above are merely the optional embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure. Therefore, the protection scope of the present disclosure is subject to the protection scope of the claims.

1. A display substrate, comprising: a base substrate and an array of pixel islands on the base substrate; wherein the pixel island includes an array of sub-pixels; the display substrate further includes a plurality of data lines and a plurality of gate lines, and a plurality of pixel aperture areas defined by intersections of the plurality of data lines and the plurality of gate lines;
wherein the sub-pixel includes a control circuit and a pixel electrode coupled to each other; the control circuit is further coupled to the corresponding data line and gate line, respectively; the control circuit is used to, under control of the gate line, control turning on or off an electrical connection between the data line and the pixel electrode; the pixel electrode is simultaneously located in at least two adjacent pixel aperture areas.

2. The display substrate according to claim 1, wherein the data line includes a first data-line portion and a second data-line portion coupled to each other; an orthographic projection of the first data-line portion onto the base substrate at least partially overlaps with an orthographic projection of the pixel electrode onto the base substrate, and an orthographic projection of the second data-line portion onto the base substrate does not overlap with the orthographic projection of the pixel electrode onto the base substrate; the second data-line portion is coupled to the control circuit;
wherein an included angle a between an extending direction of the first data-line portion and an extending direction of the pixel electrode satisfies: 0°<a<90°.

3. The display substrate according to claim 2, wherein tan(a)=i/j; j=pitch1/3, pitch1 is a width of the pixel island along an extension direction of the second data-line portion, i=pitch2/m, pitch2 is a width of the pixel island along an extension direction of the gate line, and m is the number of sub-pixels included in one row of sub-pixels in the pixel island along the extension direction of the gate line.

4. The display substrate according to claim 2, wherein i/j=1, or i/j=1/2.

5. The display substrate according to claim 3, wherein the first data-line portion and the second data-line portion both extend along a first direction; the pixel electrode extends along a second direction; the angle a is defined between the second direction and the first direction; the pixel electrode is simultaneously located in at least two pixel aperture areas adjacent to each other along the extension direction of the gate line.

6. The display substrate according to claim 5, wherein the sub-pixels are divided into a plurality of sub-pixel rows; each sub-pixel row corresponds to one gate line, and each sub-pixel in the sub-pixel row is respectively coupled to the corresponding gate line.

7. The display substrate according to claim 5, wherein the sub-pixels are divided into multiple sub-pixel rows: each sub-pixel row corresponds to two gate lines, at least a portion of the sub-pixel row is located between the two gate lines: a portion of the sub-pixels in the sub-pixel row are respectively coupled to one corresponding gate line, and another portion of the sub-pixels in the sub-pixel row are respectively coupled to another corresponding gate line.

8. The display substrate according to claim 7, wherein the sub-pixels are divided into multiple sub-pixel columns; and two adjacent sub-pixel columns correspond to the same data line; an orthographic projection of the data line onto the base substrate is located between orthographic projections of two adjacent sub-pixel columns onto the base substrate, and each sub-pixel in the two adjacent sub-pixel columns is coupled to the corresponding data line, respectively.

9. The display substrate according to claim 8, wherein the sub-pixel further includes common electrodes; the common electrode is arranged opposite to the pixel electrode; the common electrodes included in the display substrate are divided into multiple common electrode groups, and the common electrodes belonging to the same common electrode group are coupled together; the display substrate further includes touch electrodes and touch signal lines coupled to the touch electrodes; the common electrode groups are reused as the touch electrodes.

10. The display substrate according to claim 9, wherein the display substrate further includes a virtual data line; the virtual data line is located between adjacent data lines; the virtual data line is reused as the touch signal line.

11. The display substrate according to claim 3, wherein the pixel electrode and the second data-line portion both extend along a first direction, the first data-line portion extends along a second direction: an angle a is defined between the second direction and the first direction; the pixel electrode is simultaneously located in at least two pixel aperture areas adjacent to each other along the first direction.

12. The display substrate according to claim 2, wherein the base substrate includes a display area and a peripheral area located around the display area: the display substrate further includes a touch electrode and a touch signal line coupled to each other; the touch electrode is located in the display area: the touch signal line includes a first touch portion and a second touch portion coupled to each other; the first touch portion is in a same extension direction as the gate line, at least a portion of the first touch portion is located in the display area; the second touch portion is located in the peripheral area, and an extension direction of the second touch portion crosses an extension direction of the first touch portion.

13. The display substrate according to claim 12, wherein the touch signal line is located between the touch electrode and the base substrate, or the touch signal line is located on a side of the touch electrode that is away from the base substrate;
an insulating layer is provided between the touch signal line and the touch electrode, and the touch signal line is coupled to the touch electrode via a via-hole which extends through the insulating layer.

14. The display substrate according to claim 12, wherein the insulating layer includes an organic insulating layer or an inorganic insulating layer.

15. The display substrate according to claim 2, wherein the display substrate further includes a lens structure; the lens structure is located at a light-emitting side of the pixel islands; an angle between an axial direction of the lens structure and an extension direction of the gate line is greater than 0 degrees and less than 90 degrees.

16. The display substrate according to claim 15, wherein the axial direction of the lens structure is the same as the extension direction of the pixel electrode, or is the same as the extension direction of the first data-line portion.

17. A display device, comprising: a display substrate, and a color filter substrate; wherein the color filter substrate is arranged opposite to the display substrate;
wherein the display substrate includes: a base substrate and an array of pixel islands on the base substrate; wherein the pixel island includes an array of sub-pixels; the display substrate further includes a plurality of data lines and a plurality of gate lines, and a plurality of pixel aperture areas defined by intersections of the plurality of data lines and the plurality of gate lines;
wherein the sub-pixel includes a control circuit and a pixel electrode coupled to each other; the control circuit is further coupled to the corresponding data line and gate line, respectively; the control circuit is used to, under control of the gate line, control turning on or off an electrical connection between the data line and the pixel electrode; the pixel electrode is simultaneously located in at least two adjacent pixel aperture areas.

18. The display device according to claim 17, wherein the color filter substrate includes a black matrix; an extension direction of the black matrix is the same as an extension direction of the gate line in the display substrate; an orthographic projection of the black matrix onto the base substrate of the display substrate at least partially overlaps with an orthographic projection of the first touch portion in the display substrate onto the base substrate.

19. The display device according to claim 17, wherein the data line includes a first data-line portion and a second data-line portion coupled to each other: an orthographic projection of the first data-line portion onto the base substrate at least partially overlaps with an orthographic projection of the pixel electrode onto the base substrate, and an orthographic projection of the second data-line portion onto the base substrate does not overlap with the orthographic projection of the pixel electrode onto the base substrate; the second data-line portion is coupled to the control circuit;
wherein an included angle a between an extending direction of the first data-line portion and an extending direction of the pixel electrode satisfies: 0°<a<90°.

20. The display device according to claim 19, wherein tan(a)=i/j; j=pitch1/3, pitch1 is a width of the pixel island along an extension direction of the second data-line portion, i=pitch2/m, pitch2 is a width of the pixel island along an extension direction of the gate line, and m is the number of sub-pixels included in one row of sub-pixels in the pixel island along the extension direction of the gate line.
